(19) United States
(12) Patent Application Publication
(10) Pub. No.: US 2025/0300438 A1
(43) Pub. Date: Sep. 25, 2025

(54) Wire Strippers

(71) Applicant: Milwaukee Electric Tool Corporation, Brookfield, WI (US)

(72) Inventors: Christian R. Braun, Milwaukee, WI (US); Kyle A. Ritz, Burlington, WI (US)

(21) Appl. No.: 19/050,738

(22) Filed: Feb. 11, 2025

Related U.S. Application Data
(60) Provisional application No. 63/569,508, filed on Mar. 25, 2024.
(60) Provisional application No. 63/647,413, filed on May 14, 2024.

(51) Int. Cl. H02G 1/12

(52) U.S. Cl. CPC H02G 1/1209

(57) ABSTRACT

A tool for cutting wires is provided. The tool includes a first member with a first handle and a first jaw body and a second member with a second handle and a second jaw body. The first jaw body includes a first inner blade and a first projection. The second jaw body includes a second inner blade and a second projection. The second projection defines a slot with the second jaw body. The second member is pivotably coupled to the first member such that the first member and the second member move between an opened position and a closed position with respect to each other. When in the opened position, the first projection abuts the second jaw body, and the slot defines an opening configured to receive a workpiece. When in the closed position, the first projection overlaps with the slot to cut a workpiece.

### CROSS-REFERENCE TO RELATED PATENT APPLICATIONS

The present application claims the benefit of and priority to U.S. Provisional Application No. 63/647,413 filed on May 14, 2024, and U.S. Provisional Application No. 63/569,508, filed on Mar. 25, 2024, which are incorporated herein by reference in their entireties.

### BACKGROUND OF THE INVENTION

The present invention relates generally to the field of hand tools. The present invention relates specifically to a stripper tool designed to facilitate stripping the jackets from wires and cables, such as metallic cables and/or non-metallic cables.

### SUMMARY OF THE INVENTION

One embodiment of the invention relates to a hand tool with a first member and a second member. The first member includes a first handle and a first jaw body coupled to the first handle. The first jaw body includes a first tip, a first inner blade with a first linear portion extending away from the first jaw body at a first angle, a first plurality of grooves positioned along the first jaw body between the first tip and the first inner blade, and a first projection coupled to the first jaw body and extending away from the first inner blade. The second member includes a second handle and a second jaw body coupled to the second handle. The second jaw body includes a second tip, a second dinner blade with a second linear portion extending away from the second jaw body at a second angle, a second plurality of grooves positioned along the second jaw body between the second tip and the second inner blade, and a second projection coupled to a side of the second jaw body opposite the second inner blade and the second plurality of grooves. The second projection extends away from the side of the second jaw body and defines a slot. A longitudinal axis is defined between the first jaw body, the first handle, the second jaw body, and the second handle. The second member is pivotably coupled to the first member such that the first member and the second member are configured to move between an opened position and a closed position with respect to each other around a pivot axis. The pivot axis is perpendicular to the longitudinal axis. When in the opened position, the first linear portion of the first inner blade and the second linear portion of the second inner blade define a jaw opening configured to receive a workpiece. When in the opened position, the first projection abuts the second jaw body, and the slot defines a snipping opening configured to receive a workpiece. When in the closed position, the first projection overlaps with the slot.

Another embodiment of the invention relates to a cutting tool with a first member and a second member. The first member includes a first handle and a first jaw body coupled to the first handle. The first jaw body includes a first side with a first blade, a second side opposite the first side, and a first projection coupled to the first side and extending away from the first side. The first projection includes a projection cutting edge. The second member comprises a second handle and a second jaw body coupled to the second handle. The second jaw body includes a third side with a second blade facing the first side of the first jaw body, a fourth side opposite the third side, a second projection coupled to the fourth side and extending away from the fourth side, and a slot defined between the second projection and the fourth side. The slot defining an inner surface with a slot cutting edge. The second member is pivotably coupled to the first member such that the first member and the second member are configured to move between an opened position and a closed position with respect to each other around a pivot axis. When in the opened position, the first projection abuts the second jaw body, and the slot defines an opening configured to receive a workpiece. When in the closed position, the first projection overlaps with the slot such that the projection cutting edge and the slot cutting edge are configured to cut a workpiece positioned within the slot.

Another embodiment of the invention relates to a tool for cutting wires. The tool includes a first member and a second member. The first member includes a first handle and a first jaw body coupled to the first handle. The first jaw body includes a first side and a second side opposite the first side. The first side includes a first tip, a first inner blade with a first linear portion, and a first plurality of grooves positioned between the first tip and the first inner blade. A first projection is coupled to the first side adjacent to the first inner blade and extending away from the first inner blade. The first projection includes a first cutting edge. The second member is pivotably coupled to the first member about a pivot axis. The second member includes a second handle and a second jaw body coupled to the second handle. The second jaw body includes a third side facing the first side and a fourth side opposite the third side. The third side includes a second tip, a second inner blade with a second linear portion, and a second plurality of groves positioned between the second tip and the second inner blade. A second projection is coupled to the fourth side and extends away from the fourth side. A slot is defined between he second projection and the fourth side. The slot defines an inner surface with a second cutting edge. The first member and the second member are configured to move between an opened position and a closed position with respect to each other around the pivot axis. When in the opened position, the first linear portion of the first inner blade and the second linear portion of the second inner blade define an opening configured to receive a workpiece.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a hand tool, according to an exemplary embodiment;

FIG. 2 is a side view of a first jaw body and a second jaw body of the hand tool of FIG. 1 in an opened position, according to an exemplary embodiment;

FIG. 3 is a side view of the first jaw body and the second jaw body of the hand tool of FIG. 1 in an opened position, according to an exemplary embodiment;

FIG. 4 is a detailed view of a portion of the first jaw body of the hand tool of FIG. 1, according to an exemplary embodiment;

FIG. 5 is a side view of the hand tool of FIG. 1 in use with a non-metallic cable positioned between the first jaw body and the second jaw body, according to an exemplary method of using the hand tool of FIG. 1 to remove a cable jacket;

FIG. 6 is the non-metallic cable of FIG. 5 with a cut in the cable jacket from the hand tool of FIG. 1, according to an exemplary method of using the hand tool of FIG. 1 to remove a cable jacket;

FIG. 7 is the non-metallic cable of FIG. 6 with the cable jacket pulled off, according to an exemplary method of removing a cable jacket using the hand tool of FIG. 1;

FIG. 8 is a side view of the hand tool of FIG. 1, according to an exemplary embodiment;

FIG. 9 is a detail view of a first projection of the hand tool of FIG. 1, according to an exemplary embodiment;

FIG. 10 is a side view of the hand tool of FIG. 1, according to an exemplary embodiment;

FIG. 11 is a detail view of a second projection and a slot of the hand tool of FIG. 1, according to an exemplary embodiment;

FIG. 12 is a view of a metallic cable bent to create an opening in the cable jacket, according to an exemplary method of using the hand tool of FIG. 1 to remove a cable jacket;

FIG. 13 is a side view of the hand tool of FIG. 1 in use with the metallic cable of FIG. 12 positioned within the slot, according to an exemplary method of using the hand tool of FIG. 1 to remove a cable jacket;

FIG. 14 is the metallic cable of FIG. 13 with a cut in the cable jacket from the hand tool of FIG. 1, according to an exemplary method of using the hand tool of FIG. 1 to remove a cable jacket;

FIG. 15 is the metallic cable of FIG. 14 straightened, according to an exemplary method of using the hand tool of FIG. 1 to remove a cable jacket;

FIG. 16 is the metallic cable of FIG. 15 with the cable jacket pulled off, according to an exemplary method of removing a cable jacket using the hand tool of FIG. 1;

FIG. 17 is a side view of a hand tool, according to an exemplary embodiment;

FIG. 18 is a side view of the first jaw body and the second jaw body of the hand tool of FIG. 17 in an opened position with a locking mechanism in the locked position, according to an exemplary embodiment;

FIG. 19 is a detailed view of the second projection of the hand tool of FIG. 17, according to an exemplary embodiment;

FIG. 20 is a perspective view of a hand tool, according to an exemplary embodiment;

FIG. 21 is a side view of a hand tool, according to an exemplary embodiment;

FIG. 22 is a perspective view of a hand tool, according to an exemplary embodiment; and

FIG. 23 is a side view hand tool, according to an exemplary embodiment.

### DETAILED DESCRIPTION

Referring generally to the figures, various embodiments of a hand tool for stripping wires and cables are shown. Applicant believes that the hand tools discussed herein provide for various advantages over typical hand tools for wire and cable stripping, including providing greater versatility for different sized wire/cable applications.

In specific embodiments discussed herein, the hand tool includes blades configured to receive multiple non-metallic wires and cables, such as 10 AWG wires with 2 or 3 conductors and a ground within the non-metallic cable jacket, 12 AWG wires with 2 or 3 conductors and a ground within the non-metallic cable jacket, and 14 AWG wires with 2 or 3 conductors and a ground within the non-metallic cable jacket. The blades may also be configured to also receive different sized non-metallic wires and cables, such as 8 AWG wires, 10 AWG wires, 12 AWG wires, 14 AWG wires, 16 AWG wires, and 18 AWG wires. Additionally, the hand tool includes a snipping jaw defined by a first projection and a second projection configured to cut metallic wires and cables. In this way, the same hand tool can be used to strip multiple types of non-metallic wires and cables and can also be used to strip metallic wires and cables. This reduces the number of tools a user needs to accomplish wire and cable stripping tasks. Applicant believes that by reducing the number of tools needed, the hand tools discussed herein also decrease the amount of time it takes to strip wires and cables.

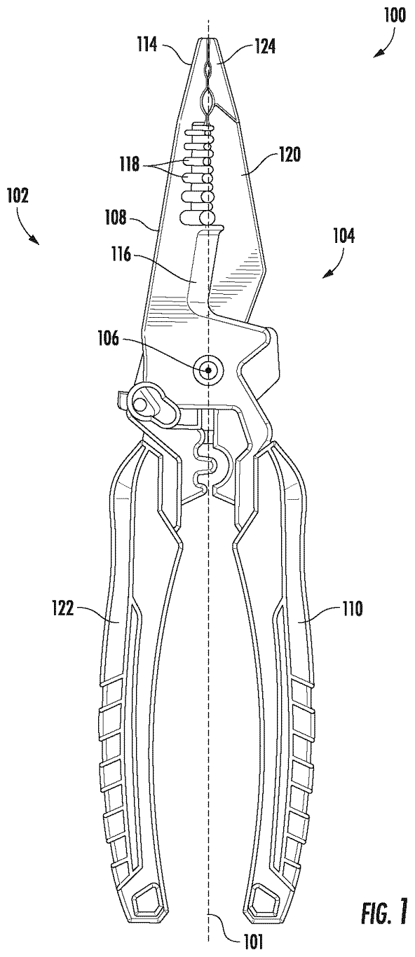

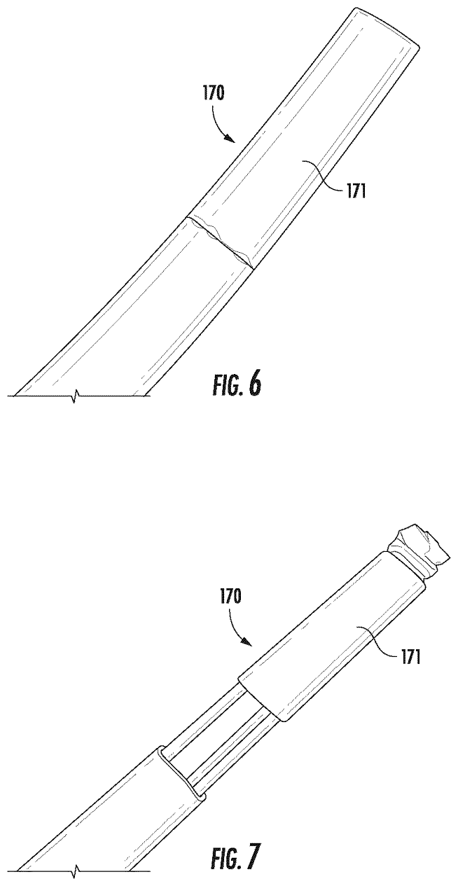

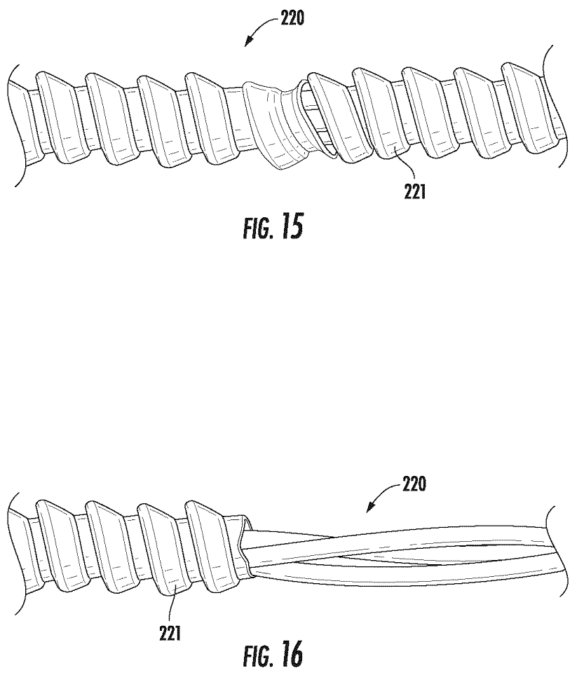

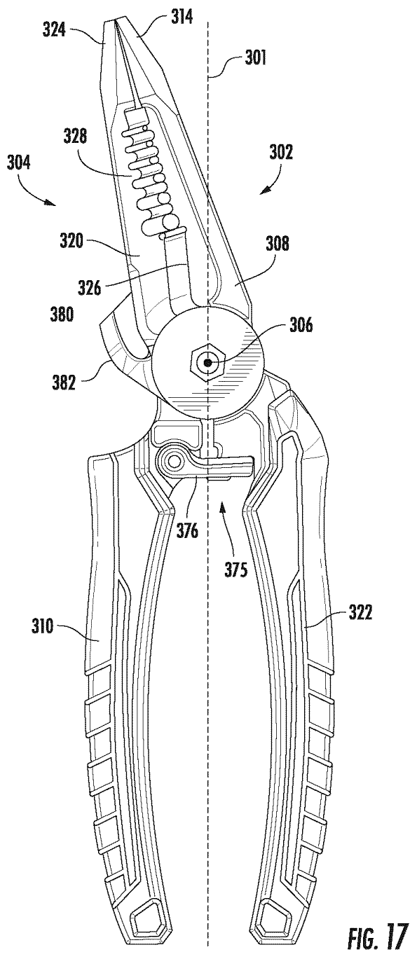

Referring to FIGS. 1-16, a hand tool, such as wire stripper 100, is shown. Wire stripper 100 includes a first member 102 and a second member 104. First member 102 includes a first jaw body 108 and a first handle 110. First jaw body 108 is coupled to first handle 110. Second member 104 includes a second jaw body 120 coupled to a second handle 122. First jaw body 108, first handle 110, second jaw body 120, and second handle 122 define a longitudinal axis such that wire stripper 100 extends along longitudinal axis 101. As shown, longitudinal axis 101 is centered between first handle 110 and second handle 122. Second member 104 is pivotably coupled to first member 102 such that first member 102 and second member 104 are configured to move between an opened position and a closed position with respect to each other around a pivot axis 106. As shown, first jaw body 108 is coupled to second jaw body 120 and longitudinal axis 101 intersects with pivot axis 106. As shown, longitudinal axis 101 is perpendicular to pivot axis 106.

First handle 110 is configured to be held by a user of wire stripper 100 when the user actuates first member 102 and second member 104 between the opened and closed positions. Second handle 122 is configured to be held by a user of wire stripper 100 when a user actuates first member 102 and second member 104 between the opened and closed positions. When moved between the opened position and the closed position, first jaw body 108 and second jaw body 120 pivot with respect to each other towards and away from longitudinal axis 101.

First jaw body 108 includes a first tip 114, a first inner blade 116, and a first plurality of grooves, shown as a first plurality of U-shaped blades 118. In other various embodiment, the first plurality of grooves may be another shaped blade, such as C-shaped blades. First tip 114 is tapered such that it is configured to be wedged between a wire/cable and its insulation/jacket. First tip 114 includes a gripping surface 113 to allow for gripping when first tip 114 is used to grab a workpiece, such as a wire, cable, or jacket.

First plurality of U-shaped blades 118 are positioned between first inner blade 116 and first tip 114 in a direction along longitudinal axis 101. First plurality of U-shaped blades 118 are defined in first jaw body 108. Each first U-shaped blade 118 is configured (e.g., sized and shaped) to receive a different sized wire for stripping (e.g., 8 AWG-18 AWG). As shown, first jaw body 108 includes six first U-shaped blades 118. First U-shaped blades 118 are positioned in order of size, where the largest U-shaped blade 118 is adjacent to first inner blade 116 (e.g., 8 AWG) and the smallest U-shaped blade 118 is adjacent to first tip 114 (e.g., 18 AWG).

Second jaw body 120 includes a second tip 124, a second inner blade 126, and a second plurality of grooves, shown as a second plurality of U-shaped blades 128. Second tip 124 is tapered such that it is configured to be wedged between a cable/wire and its jacket/insulation. Second tip 124 includes a gripping surface 123 to allow for gripping when second tip 124 is used to grab a workpiece.

Second plurality of U-shaped blades 128 are positioned between second inner blade 126 and second tip 124 along blade axis 112. Second plurality of U-shaped blades 128 are defined in second jaw body 120. Each second U-shaped blade 128 is configured (e.g., sized and shaped) to receive a different sized wire for stripping (e.g., 8 AWG-18 AWG). As shown, second jaw body 120 includes six second U-shaped blades 128, which each correspond to a first U-shaped blade 118 formed in first jaw body 108. Together, first U-shaped blades 118 and second U-shaped blades 128 define apertures configured to receive a workpiece.

When a workpiece, such as a wire or cable, is placed within an aperture defined between pairs of first U-shaped blades 118 and second U-shaped blades 128, the U-shaped blades 118, 128 can be used to strip/remove the jacket, or insulation, from the wire/cable. When first member 102 and second member 104 are moved into the closed position, the U-shaped blades 118, 128 make an incision in the jacket. While still in the closed position, a user may strip the jacket from the wire/cable by pulling the U-shaped blades 118, 128 along the length of wire/cable.

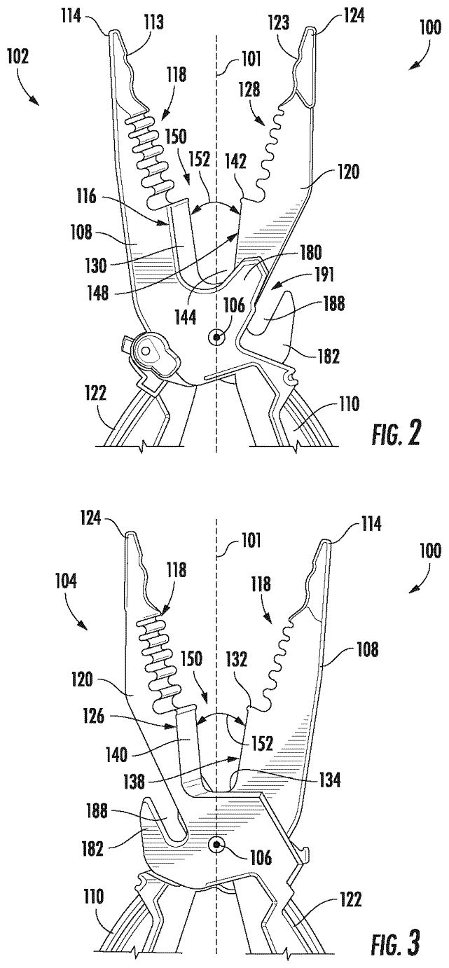

Referring to FIGS. 2-3, first member 102 and second member 104 are in the opened position. When in the opened position, a workpiece may be received between first inner blade 116 of first jaw body 108 and second inner blade 126 of second jaw body 120. Inner blades 116, 126 are configured to cut and/or score a workpiece.

First inner blade 116 of first jaw body 108 has a first linear portion 130, a first lip 132, and a first end 134. First linear portion 130 extends between first lip 132 and first end 134. First linear portion 130 extends away from first jaw body 108 at a first angle 136. First linear portion 130 includes a first cutting edge 138. First lip 132 protrudes from first linear portion 130 and is positioned adjacent to first U-shaped blades 118. First lip 132 has a curved outer surface, which is used to retain a workpiece along first linear portion 130 between first lip 132 and first end 134. First end 134 is positioned opposite first lip 132 along first linear portion 130. First end 134 has a curved outer surface shaped to receive a jacket of a wire/cable.

Second inner blade 126 of second jaw body 120 is substantially the same as first inner blade 116 of first jaw body 108. Second inner blade 126 of second jaw body 120 has a second linear portion 140, a second lip 142, and a second end 144. Second linear portion 140 extends between second lip 142 and second end 144. Second linear portion 140 extends away from second jaw body 120 at a second angle. The second angle is substantial the same as first angle 136. Second linear portion 140 includes a second cutting edge 148. Second lip 142 protrudes from second linear portion 140 and is positioned adjacent to second U-shaped blades 128. Second lip 142 has a curved surface, which is used to retain a workpiece along second linear portion 140 between second lip 142 and second end 144. Second end 144 is positioned opposite second lip 142 along second linear portion 140. Second end 144 has a curved surface shaped to receive a jacket of a wire/cable.

As shown, when in the opened position, first linear portion 130 of first inner blade 116 and second linear portion 140 of second inner blade 126 define a jaw opening 150. In various embodiments, jaw opening 150 is defined by an opening angle 152 between first linear portion 130 and second linear portion 140. More specifically, opening angle 152 is measured between first cutting edge 138 and second cutting edge 148. Opening angle 152 varies as wire stripper 100 is moved between the opened position and the closed position.

Jaw opening 150 is configured to receive a workpiece. In particular, jaw opening 150 is configured to receive different sized wires and cables such that wire stripper 100 may be used to strip a variety of sized wires/cables (e.g., 14 AWG with 2 or 3 conductor wires plus ground in a non-metallic jacket and 10 AWG with 2 or 3 conductor wires plus ground in a non-metallic jacket). When a work piece is positioned between first inner blade 116 and second inner blade 126, the lips 132, 142 assist in retaining the workpiece within jaw opening 150.

In a specific embodiment, when wire stripper 100 is in the opened position, opening angle 152 is at least 15 degrees. In a specific embodiment, when wire stripper 100 is in the opened position, opening angle 152 is no more than 25 degrees. Additionally, the opening angle 152 may vary based on the size of the cable/wire that wire stripper 100 is configured to cut or scored. In a specific embodiment, wire stripper 100 is configured to score different sized wires. In such an embodiment, opening angle 152 is at least 18 degrees. In particular, opening angle 152 is 18.5 degrees when scoring 14 AWG non-metallic wires, 20 degrees when scoring 12 AWG non-metallic wires, and 21 degrees when scoring 10 AWG non-metallic wires.

In a specific embodiment, when a workpiece is received in jaw opening 150 and first inner blade 116 and second inner blade 126 are moved to abut the workpiece, then first linear portion 130 and second linear portion 140 are substantially parallel to each other.

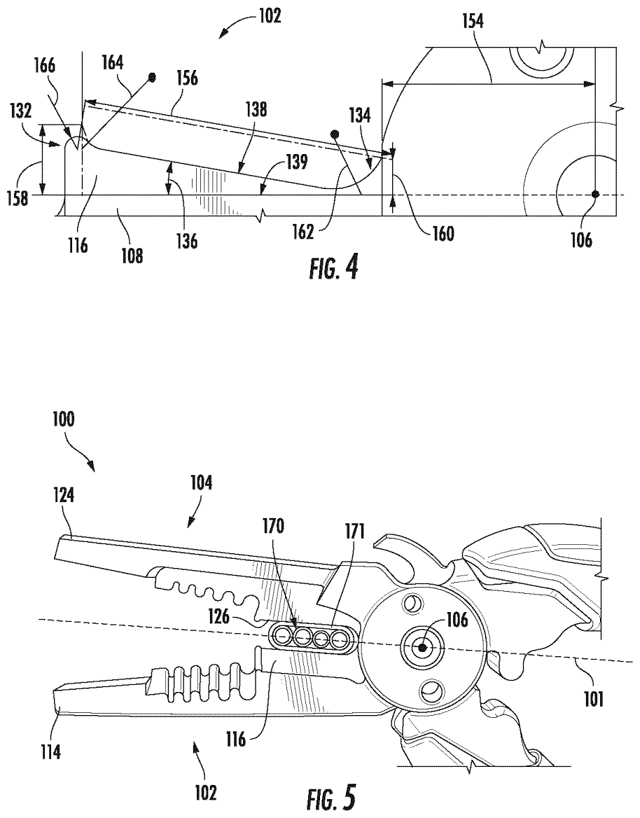

Referring to FIG. 4, a detailed view of first inner blade 116 of first jaw body 108 is shown. Second inner blade 126 of second jaw body 120 is sized and shaped substantially the same as first inner blade 116 of first jaw body 108. As shown, first cutting edge 138 extends away from a base 139 of first inner blade 116 at first angle 136. First angle 136 is measured between first cutting edge 138 and base 139. In a specific embodiment, angle is at least 5 degrees. In a specific embodiment, angle is at most 15 degrees. In a specific embodiment, first angle 136 is between 5 degrees and 15 degrees and, more specifically, is between 8 degrees and 12 degrees. In a specific embodiment, first angle 136 is 10 degrees.

First inner blade 116 is spaced a distance 154 from pivot axis 106. More specifically, distance 154 is measured between first end 134 and pivot axis 106. In a specific embodiment, distance 154 is at least 9.00 mm and is at most 13.00 mm and, more specifically, is 11.66 mm. Further, first inner blade 116 has a length 156 measured between a center of first lip 132 and first end 134. In a specific embodiment, length 156 is at least 16.00 mm, and more, specifically, is at least 16.50 mm. A length of at least 16.50 mm is the minimum length needed for first inner blade 116 to receive non-metallic cables with three 10 AWG conductor wires and a ground.

In various embodiments, the height of first inner blade 116 varies along length 156. A height 158 is measured at first lip 132, and a height 160 is measured at first end 134. In a specific embodiment, height 158 is greater than height 160. In a specific embodiment, height 158 is at least 3.00 mm and height 160 is at least 1.50 mm. In a specific embodiment, height 158 is at most 4.00 mm and height 160 is at most 2.50 mm. In a specific embodiment, height 158 is 3.83 mm and height 160 is 2.00 mm.

Additionally, the curved surface of first end 134 has a radius of curvature 162, and curved surface of first lip 132 has a radius of curvature 164. In a specific embodiment, radius of curvature 162 is at least 2.00 mm and is at most 4.00 mm, and, more specifically, radius of curvature 162 is 3.00 mm. In a specific embodiment, a radius of curvature 164 of first lip 132 is at least 0.50 mm and is at most 2.50 mm and, more specifically, is 1.50 mm. In a specific embodiment, first lip 132 is a semi-circular shape. In such an embodiment, first lip 132 has a radius 166. In a specific embodiment, radius 166 is between 0.50 mm and 1.00 mm and, more specifically, is 0.70 mm.

Referring to FIGS. 5-7, a method of using wire stripper 100 to cut or score a workpiece with inner blades 116, 126 is shown. A workpiece, shown as cable 170, is received in wire stripper 100 between first member 102 and second member 104. As shown, cable 170 includes a cable jacket 171, and a plurality of wires are positioned within cable jacket 171. In particular, cable 170 is a non-metallic cable with 2 conductor wires and a ground. In order to strip jacket 171 from cable 170, first, cable 170 is positioned within jaw opening 150 between first inner blade 116 and second inner blade 126. Next, wire stripper 100 is moved from the opened position towards the closed position such that jacket 171 is scored by inner blades 116, 126, and opening angle 152 of jaw opening 150 is reduced. Please note that wire stripper 100 does not cut through the wires within cable 170. Finally, the user can use wire stripper 100 or their hands to pull jacket 171 along the length of cable 170, which breaks jacket 171 along the score line and allows a portion of jacket 171 to be removed from cable 170.

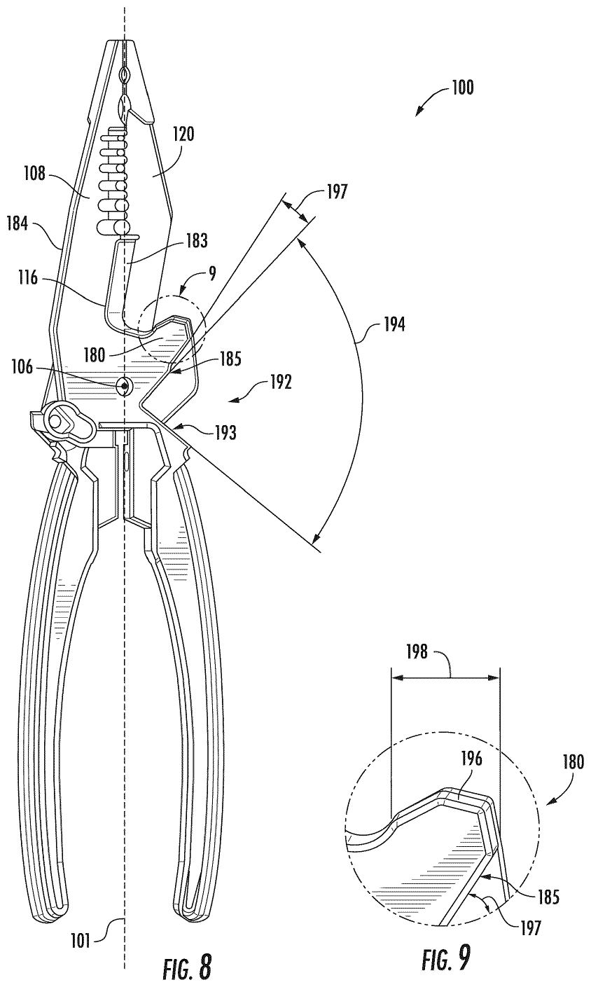

Referring to FIGS. 8-11, wire stripper 100 further includes a snipping jaw for metallic cable jackets. In general, the snipping jaw allows a user to strip metallic (or metal-clad) cables by providing projections configured (e.g. sized and shaped) to engage with a metallic cable jacket. In this way, wire stripper 100 may be used to strip non-metallic wires and cables as well as metallic wires and cables. Specifically, the snipping jaw is defined by a first projection 180 coupled to first jaw body 108 and a second projection 182 coupled to second jaw body 120.

First projection 180 coupled to first jaw body 108 and extends away from first inner blade 116. Specifically, first jaw body 108 includes a first side 183 and a second side 184 opposite the first side 183. First side 183 is located closer to longitudinal axis 101 than second side 184. First plurality of U-shaped blades 118 and first inner blade 116 are defined along the first side 183. First projection 180 is coupled to first side 183 and extends away from first side 183 and away from second side 184. First projection 180 has a projection cutting edge 185 defined along an outer wall. Projection cutting edge 185 is located on an outer wall of first projection 180 furthest from first inner blade 116. In a specific embodiment, first projection 180 and first jaw body 108 are formed from a single, unitary, continuous, contiguous piece of material.

Second jaw body 120 includes a third side 186 and a fourth side 187 opposite third side 186. Second plurality of U-shaped blades 128 and second inner blade 126 are defined along the third side 186. Second projection 182 is coupled to fourth side 187 and extends away from fourth side 187, away from third side 186, and away from first jaw body 108. Second projection 182 is coupled to fourth side 186 of second jaw body 120 second inner blade 126 and second plurality of U-shaped blades 128. Second projection 182 defines a slot 188. Slot 188 is defined between second projection 182 and fourth side 187. Slot 188 has an inner surface 189. At least a portion of inner surface 189 has a slot cutting edge 190. In a specific embodiment, second projection 182 and second jaw body 120 are formed from a single, unitary, continuous, contiguous piece of material.

When wire stripper 100 is in the opened position, first projection 180 abuts second jaw body 120. First projection 180 is positioned entirely against a rear surface of second jaw body 120 (as shown in FIG. 2). When wire stripper 100 is in the opened position, second projection 182 is spaced a distance away from first projection 180 and away from projection cutting edge 185 of first projection 180. When in the opened position, slot 188 is positioned between first projection 180 and second projection 182. In this way, slot 188 defines a snipping opening 191 configured to receive a workpiece. Snipping opening 191 is defined between projection cutting edge 185 and slot cutting edge 190.

When wire stripper 100 is in the closed position, first projection 180 overlaps with slot 188 and second projection 182. Projection cutting edge 185 is positioned along second projection 182 such that projection cutting edge 185 is located adjacent to slot cutting edge 190. When a workpiece is positioned within slot 188 and wire stripper 100 is moved from the opened position to the closed position, projection cutting edge 185 and slot cutting edge 190 are configured to cut the workpiece.

Referring to FIGS. 8-9, first jaw body 108 includes an angled cut-out 192 that defines at least a portion of projection cutting edge 185. Angled cut-out 192 is formed in first side 183 of first jaw body 108. Cut-out 192 provides clearance when first projection 180 engages with a cable or wire. Cut-out 192 defines a linear edge 193 and an angle 194. Linear edge 193 is positioned opposite projection cutting edge 185 along cut-out 192. When in the opened position, second projection 182 and slot 188 are positioned between projection cutting edge 185 and linear edge 193. Angle 194 is measured between projection cutting edge 185 and linear edge 193. In a specific embodiment, angle 194 is between 80 degrees and 90 degrees and, more specifically, is 85 degrees.

A first distance is defined between linear edge 193 to a projection tip 196 of first projection 180. In a specific embodiment, the first distance is between 20.00 mm and 30.00 mm and, more specifically, is 25.00 mm. A second distance is measured from pivot axis 106 to tip 196. In a specific embodiment, second distance is between 5.00 mm and 15.00 mm and, more specifically, is 10.00 mm. A third distance is measured from a center of cut-out 192 to tip 196. In a specific embodiment, third distance is between 10.00 mm and 20.00 mm and, more specifically, is 16.00 mm.

As shown, projection tip 196 has a taper. Specifically, tip 196 is structures to provide overlap with slot 188 and overlap with cutting edge 190 of slot 188. In a specific embodiment, tip 196 is angled away from cut-out 192. Specifically, tip 196 defines an angle 197 along projection cutting edge 185. In a specific embodiment, angle 197 is between 1 degree and 20 degrees and, more specifically, is 10 degrees. Projection tip 196 has a width 198. In a specific embodiment, width 198 is between 5.00 mm and 15.00 mm and, more specifically, is 9.00 mm.

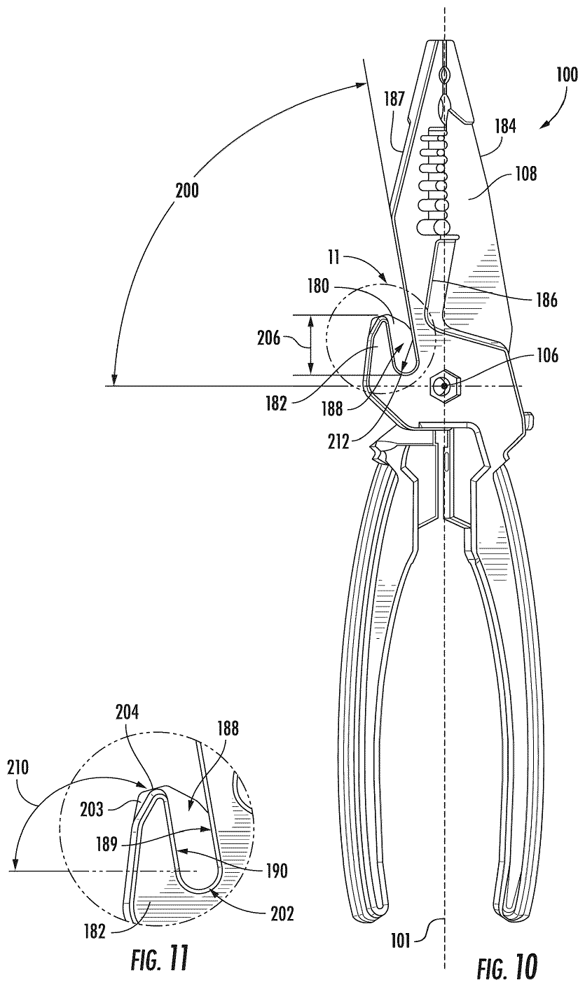

Referring to FIG. 10-11, second projection 182 defines an angle 200. Angle 200 is measured as the angle between fourth side 187 of second jaw body 120 and an end 202 of slot 188. In a specific embodiment, angle 200 is between 60 degrees and 90 degrees. In a specific embodiment, angle 200 is between 70 degrees and 85 degrees, and, more specifically, is 80 degrees.

Second projection 182 has a projection tip 204 configured to pry or wedge under a cable jacket. In particular, projection tip 204 has a tapered surface 205. In a specific embodiment, tapered surface 205 has a length between 3.00 mm and 6.00 mm and, more specifically, is 4.00 mm. In a specific embodiment, a distance from end 202 of slot 188 to tapered surface 205 is between 7.00 mm and 15.00 mm and, more specifically, is 9.00 mm. In a specific embodiment, tip 204 has a radius of curvature between 0.50 mm and 2.00 mm. In a specific embodiment, the radius of curvature of tip 204 is no more than 1.50 mm. In a specific embodiment, the radius of curvature of tip 204 is 1.00 mm.

Second projection 182 has a height 206 measured from end 202 of slot 188 to tip 204. In a specific embodiment, height 206 is between 10.00 mm and 20.00 mm and, more specifically, is 13.00 mm.

As shown, an angle 210 is defined between end 202 of slot 188 and tip 204. In a specific embodiment, angle 210 greater than 110 degrees. In a specific embodiment, angle 210 is less than 130 degrees. In a specific embodiment, angle 210 is 120 degrees.

Slot 188 has an inner surface 189 defined between fourth side 187 and second projection 182. Inner surface 189 has a first height defined along fourth side 187. In a specific embodiment, first height is between 50.00 mm and 25.00 mm and, more specifically, is 35.00 mm. Inner surface 189 defines a second height along second projection 182. In a specific embodiment, second height is between 10.00 mm and 20.00 mm and, more specifically, is 13.00 mm.

Additionally, slot 188 has a width defined between fourth side 187 and cutting edge 190. The width may vary along the second height of slot 188 such that width is narrower near end 202 than near opening 191. In a specific embodiment, slot 188 has a width between 3.00 mm and 6.00 mm and, more specifically is 4.50 mm. End 202 defines a curved portion of inner surface 189. Curved portion of end 202 has a radius of curvature 212. In a specific embodiment, the radius of curvature 212 is between 2.00 mm and 5.00 mm and more specifically, is 2.50 mm.

In various embodiments, the thickness of first projection 180 and second projection 182 is between 2.00 mm and 8.00 mm and, more specifically, the thickness is 5.00 mm.

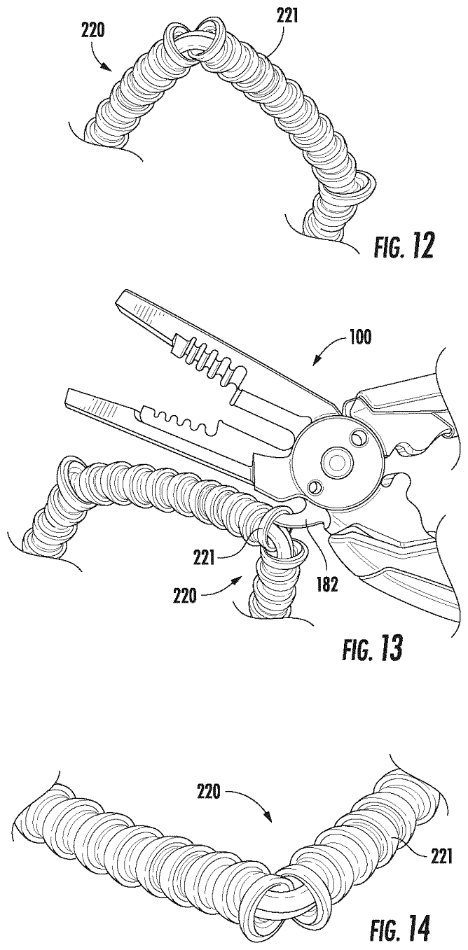

Referring to FIG. 12-16, a method of using wire stripper 100 to cut a workpiece, such as a cable 220, with the snipping jaw is shown. As shown, cable 220 is a metallic cable, or a metal-clad cable. Cable 220 has a jacket 221 which surrounds a plurality of wires. First, cable 220 is bent. The bend in cable 220 creates a gap in jacket 221. A user can bend cable 220 using their hands, wire stripper 100, or another tool. Then wire stripper 100 is moved into the opened position and the user inserts second projection 182 into the gap and under jacket 221. When a user actuates wire stripper 100 into the closed position, first projection 180 and second projection cut through jacket 221. Specifically, projection cutting edge 185 and slot cutting edge 190 cut jacket 221. After the cut is made, the user straightens out cable 220. The user can straighten cable 220 using their hands, wire stripper 100, or another tool. After cable 220 has been straightened, jacket 221 can be twisted. Twisting jacket 221 breaks jacket 221 along the cut and allows the user to remove a portion of jacket 221 from cable 220.

Referring to FIGS. 17-19, a wire stripper 300 is shown. Wire stripper 300 is substantially the same a wire stripper 100, except for the differences as discussed herein. Specifically, wire stripper 300 includes a locking mechanism.

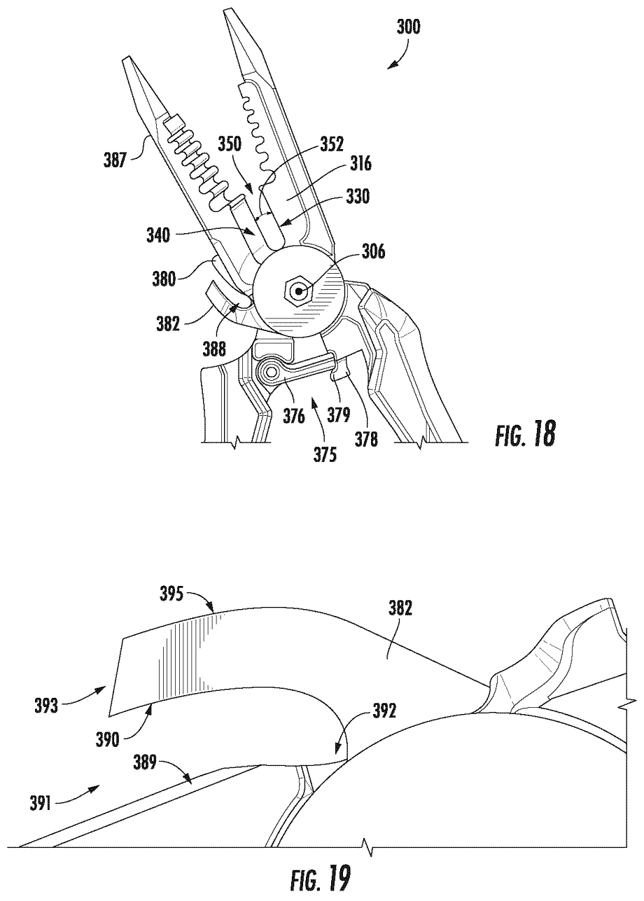

Referring to FIGS. 17-18, wire stripper 300 extends along a longitudinal axis 301. Wire stripper 300 has a first member 302 and a second member 304. Second member 304 is pivotably coupled to first member 302 such that first member 302 and second member 304 are configured to move between an opened position and a closed position with respect to each other around a pivot axis 306. First member 302 includes a first jaw body 308 and a first handle 310. First jaw body 308 is coupled to first handle 310. Second member 304 includes a second jaw body 320 and a second handle 322. Second jaw body 320 is coupled to second handle 322. First handle 310 and second handle 322 define longitudinal axis 30, and longitudinal axis 301 is centered between first handle 310 and second handle 322. First jaw body 308 and second jaw body 320 are angled away from longitudinal axis 301.

First jaw body 308 includes a first inner blade 316, and second jaw body 320 includes a second inner blade 326. When wire stripper 300 is in the opened position, a workpiece may be received between first inner blade 316 and second inner blade 326. Inner blades 316, 326 are configured to cut and/or score a workpiece. As shown in FIG. 18, when in the opened position, a first linear portion 330 of first inner blade 316 and a second linear portion 340 of second inner blade 326 define a jaw opening 350. In various embodiments, jaw opening 350 is defined by an angle 352 between first linear portion 330 and second linear portion 340. Angle 352 varies as wire stripper 300 is moved between the opened position and the closed position.

Wire stripper 300 further includes a locking mechanism 375 configured to limit the movement of first member 302 and second member 304 with respect to each other. Locking mechanism 375 includes a lever 376 and a lock 378. Lever 376 is configured to actuate between a locked position and an unlocked position. Lock 378 is configured to receive lever 376 and retain lever 376 in the locked or unlocked position. As shown in FIG. 17, when lever 376 is actuated into the locked position, lever 376 may engage with lock 378 such that wire stripper 300 is retained in the closed position until lever 376 is actuated into the unlocked position.

As shown in FIG. 18, locking mechanism 375 may also be used to retain wire stripper 300 in an opened position. Lock 378 include a step 379. Step 379 is configured to receive lever 376. When lever 376 is in the locked position and is received in step 379, step 379 is configured to maintain wire stripper 300 in an opened position such that first member 302 and second member 304 are unable to decrease the angle 352 of jaw opening 350 beyond a pre-selected angle. As shown, lock 378 includes one step 379. In various embodiments, lock 378 includes multiple steps each used to maintain a different angle 352 of jaw opening 350.

In various embodiments, angle 352 is at least 15 degrees when lever 376 is retained in step 379. In a specific embodiment, angle 352 is at least 15 degrees and at most 25 degrees when lever 376 is retained in step 379. In a specific embodiment, angle 352 is at least 18 degrees.

In a specific embodiment, step 379 is configured (e.g., is spaced or positioned) to define an angle for scoring a 10 AWG non-metallic wire. In such an embodiment, angle 352 is at least 21 degrees when lever 376 is retained in step 379. In a specific embodiment, step 379 is configured to define an angle for scoring a 12 AWG non-metallic wire. In such an embodiment, angle 352 is at least 20 degrees when lever 376 is retained in step 379. In a specific embodiment, step 379 is configured to define an angle for scoring a 14 AWG non-metallic wire. In such an embodiment, angle 352 is at least 18.5 degrees when lever 376 is retained in step 379.

Wire stripper 300 further includes a first projection 380 coupled to first jaw body 308 and a second projection 382 coupled to second jaw body 320. First projection 380 is substantially the same as first projection 180, and second projection 382 is substantially the same as second projection 182, except for the differences discussed herein.

Referring to FIG. 19, second projection 382 is shown. Second projection defines a slot 388. Second projection 382 is coupled to a fourth side 387 and extends away from fourth side 387. Slot 388 is defined between second projection 382 and fourth side 387. Slot 388 has an inner surface 389 which defines a slot cutting edge 390. Slot 388 defines a snipping opening 391 configured to receive a workpiece.

Second projection 382 has a projection tip 393 configured to pry or wedge under a cable jacket. In a specific embodiment, projection tip 393 is tapered. In a specific embodiment, tip 393 has a width between 3.00 mm and 5.00 mm and, more specifically, is 4.00 mm. Second projection 382 has a length measured from an end 394 of slot 388 to tip 393. In a specific embodiment, the length is between 8.00 mm and 11.00 mm and, more specifically, is 9.00 mm. Second projection 382 has a width measured between cutting edge 390 of slot 388 and an outer edge 395 of second projection 382. In a specific embodiment, the width is between 3.00 mm and 5.00 mm and, more specifically, is 4.25 mm.

In a specific embodiment, slot 388 has a length that is between 8.00 mm and 12.00 mm. In a specific embodiment, the length is between 10.00 mm and 11.00 mm and, more specifically, is 10.75 mm. Slot 388 has a width that varies along its length. In various embodiment, slot 388 has a small width at end 394 than at opening 391. In a specific embodiment, a first width of slot 388 is measured between projection tip 393 and fourth side 387. In a specific embodiment, first width is between 4.00 mm and 5.00 mm and, more specifically, is 4.50 mm. In a specific embodiment, a second width of slot 388 is measured between cutting edge 390 and fourth side 387. In a specific embodiment, second width is between 3.00 mm and 5.00 mm and, more specifically, is 4.00 mm. In a specific embodiment, a third width of slot 388 is measured at end 394 of slot 388. In a specific embodiment, third width is between 3.00 mm and 4.00 mm and, more specifically, is 3.50 mm.

Referring to FIG. 20, a hand tool, such as wire stripper 400 is shown. Wire stripper 400 is believed to provide benefits over other wire strippers such as by increasing efficiency, increasing safety, and minimizing tool swapping. In particular, wire stripper 400 is configured to receive wires and cables within a portion of its body 402. In specific embodiments, body 402 is made of a first portion 404 and a second portion 406 coupled together by a hinge 408 such that first portion 404 can pivot with respect to second portion 406. In this way, body 402 is configured to move between an opened and a closed position. An opening 410 is defined in body 402. Opening 410 is configured to receive cables/wires of varying sizes, such as 10 AWG wires with 2 or 3 conductors and a ground within the non-metallic cable jacket, 12 AWG wires with 2 or 3 conductors and a ground within the non-metallic cable jacket, and 14 AWG wires with 2 or 3 conductors and a ground within the non-metallic cable jacket. In specific embodiments, wire stripper 400 has improved grip for manipulating wires and cables, such as underground feeder cable. In specific embodiments, the grip is used for twisting and bending wires/cables, such as J-hooking wires. In various embodiments, wire stripper 400 includes a size selector in which a user can select the size of opening 410 based on the user's needs. Wire stripper 400 may also be configured to strip individual wires after stripping a cable jacket.

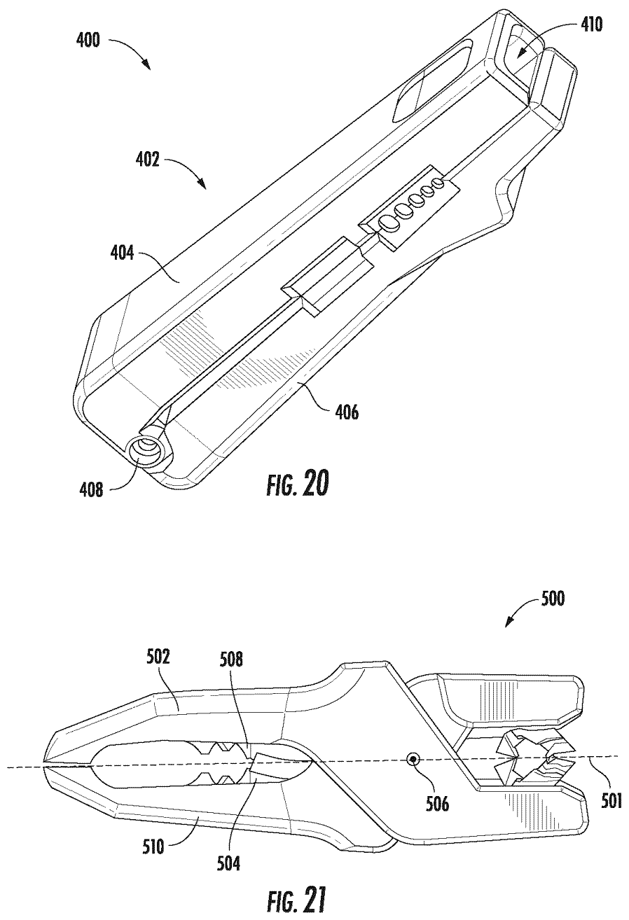

Referring to FIG. 21, a hand tool, such as wire stripper 500 is shown. Wire stripper 500 is believed to provide benefits over other wire strippers such as by increasing efficiency and increasing safety. Wire stripper 500 extends along a longitudinal axis 501 and includes a first member 502 pivotably coupled to a second member 504. First member 502 and second member 504 are configured to move between an opened position and a closed position with respect to each other around a pivot axis 506. As shown, wire stripper 500 includes first blade portion 508 and second blade portion 510. In various embodiments, first blade portion 508 and second blade portion 510 are configured to automatically adjust based on the size of wire or cable positioned between them. In specific embodiments, wire stripper 500 is configured to receive and strip cables/wires of varying sizes, such as 10 AWG wires with 2 or 3 conductors and a ground within the non-metallic cable jacket, 12 AWG wires with 2 or 3 conductors and a ground within the non-metallic cable jacket, and 14 AWG wires with 2 or 3 conductors and a ground within the non-metallic cable jacket. Wire stripper 500 may also be configured to strip individual wires after stripping a cable jacket.

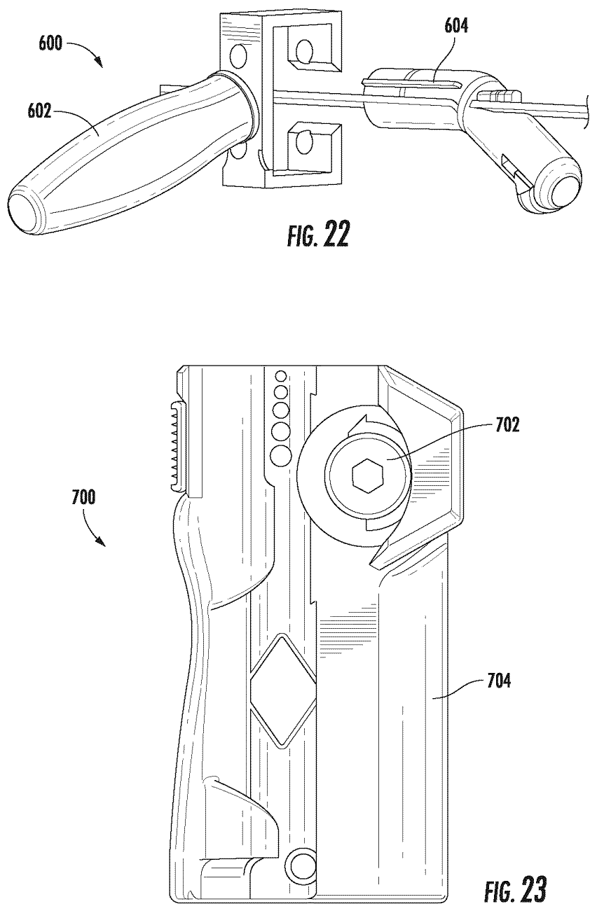

Referring to FIG. 22, a hand tool, such as wire stripper 600, is shown. Wire stripper 600 is believed to provide benefits over other wire strippers such as by increasing efficiency and increasing safety. Wire stripper 600 includes a clamp, or grip portion 602, and a cutting portion 604. Cutting portion 604 is configured to receive a cable or wire within it. When cutting portion 604 is pulled along the cable or wire, cutting portion 604 strips the jacket from the cable/wire. Grip portion 602 is used to position and guide cutting portion 604. In various embodiments, wire stripper 600 is configured to automatically adjust based on the size of wire or cable positioned between them. In specific embodiments, wire stripper 600 is configured to receive and strip cables/wires of varying sizes, such as 10 AWG wires with 2 or 3 conductors and a ground within the non-metallic cable jacket, 12 AWG wires with 2 or 3 conductors and a ground within the non-metallic cable jacket, and 14 AWG wires with 2 or 3 conductors and a ground within the non-metallic cable jacket. Wire stripper 600 may also be configured to strip individual wires after stripping a cable jacket.

Referring to FIG. 23, a hand tool, such as wire stripper 700, is shown. Wire stripper 700 is believed to provide benefits over other wire strippers such as by increasing efficiency, being more compact, and minimizing tool swapping. Wire stripper 700 includes a blade 702 rotatably coupled to a body 704. Body 704 is configured to receive a wire or a cable within body 704. Wire stripper 700 may be electrically or mechanically powered. In various embodiments, body 704 is shaped to be used in narrow or tight spaces. Wire stripper 700 is configured to receive and strip cables/wires of varying sizes and types, such as metallic and non-metallic cables/wires. For instance, wire stripper 700 may be used on as 10 AWG wires with 2 or 3 conductors and a ground within the non-metallic cable jacket, 12 AWG wires with 2 or 3 conductors and a ground within the non-metallic cable jacket, and 14 AWG wires with 2 or 3 conductors and a ground within the non-metallic cable jacket. Wire stripper 700 may also be used on metallic cables. In specific embodiments, wire stripper 700 is configured to strip individual wires after stripping a cable jacket.

In various embodiments, the wire strippers may be electrically powered, such as by a rechargeable battery cell. In such embodiments, the wire strippers may include an elongate body that is structured to be used in narrow or tight spaces. The elongate body may include a blade end, and a grip end opposite the blade end. The blade end includes a blade configured to cut a wire or cable, such as metallic cable. The blade may be configured to rotate with respect to the elongate body. The grip end is configured to be held by a user of the wire strippers. The grip end may include an opening configured to receive and retain a battery, such as a rechargeable battery. In such embodiments, the powered wire stripper is configured to receive and strip cables/wires of varying sizes and types, such as metallic and non-metallic cables/wires. For instance, the wire stripper may be used on as 10 AWG wires with 2 or 3 conductors and a ground within the non-metallic cable jacket, 12 AWG wires with 2 or 3 conductors and a ground within the non-metallic cable jacket, and 14 AWG wires with 2 or 3 conductors and a ground within the non-metallic cable jacket. The wire stripper may also be used on metallic cables. In specific embodiments, the wire stripper is configured to strip individual wires after stripping a cable jacket.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A hand tool, comprising:
a first member comprising a first handle and a first jaw body coupled to the first handle, the first jaw body comprising:
a first tip;
a first inner blade comprising a first linear portion extending away from the first jaw body at a first angle;
a first plurality of grooves positioned along the first jaw body between the first tip and the first inner blade; and
a first projection coupled to the first jaw body and extending away from the first inner blade;
a second member comprising a second handle and a second jaw body coupled to the second handle, the second jaw body comprising:
a second tip;
a second inner blade comprising a second linear portion extending away from the second jaw body at a second angle;
a second plurality of grooves positioned along the second jaw body between the second tip and the second inner blade; and
a second projection coupled to a side of the second jaw body opposite the second inner blade and the second plurality of grooves, wherein the second projection extends away from the side of the second jaw body and defines a slot;
wherein a longitudinal axis is defined between the first jaw body, the first handle, the second jaw body, and the second handle;
wherein the second member is pivotably coupled to the first member such that the first member and the second member are configured to move between an opened position and a closed position with respect to each other around a pivot axis, wherein the pivot axis is perpendicular to the longitudinal axis;
wherein, when in the opened position, the first linear portion of the first inner blade and the second linear portion of the second inner blade define a jaw opening configured to receive a workpiece; and
wherein, when in the opened position, the first projection abuts the second jaw body, and the slot defines a snipping opening configured to receive a workpiece, and, when in the closed position, the first projection overlaps with the slot.

2. The hand tool of claim 1, wherein the first angle and the second angle are the same.

3. The hand tool of claim 1, wherein the first angle is at least 5 degrees and is at most 15 degrees.

4. The hand tool of claim 1, wherein, when in the opened position, the first linear portion and the second linear portion are parallel to each other.

5. The hand tool of claim 1, wherein the jaw opening is defined by an opening angle between the first linear portion and the second linear portion, wherein, when in the opened position, the opening angle is at most 25 degrees.

6. The hand tool of claim 1, wherein each first groove in the first plurality of grooves is a U-shaped blade, and wherein each second groove in the second plurality of grooves is a U-shaped blade.

7. The hand tool of claim 1, wherein the first inner blade further comprises a lip and an end, wherein the first linear portion extends between the lip and the end, and the lip is positioned between the first linear portion and the first plurality of grooves.

8. The hand tool of claim 7, wherein the lip is a semi-circular shape and has a radius, wherein the radius is between 0.50 mm and 1.00 mm.

9. The hand tool of claim 7, wherein the end comprises a curved outer surface, wherein the curved outer surface has a radius of curvature, wherein the radius of curvature is at least 2.00 mm and is at most 4.00 mm.

10. A cutting tool, comprising:
a first member comprising a first handle and a first jaw body coupled to the first handle, the first jaw body comprising:
a first side with a first blade;
a second side opposite the first side; and
a first projection coupled to the first side and extending away from the first side, the first projection comprising a projection cutting edge;
a second member comprising a second handle and a second jaw body coupled to the second handle, the second jaw body comprising:
a third side with a second blade, the third side facing the first side of the first jaw body;
a fourth side opposite the third side;
a second projection coupled to the fourth side, the second projection extending away from the fourth side; and
a slot defined between the second projection and the fourth side, the slot defining an inner surface with a slot cutting edge;
wherein the second member is pivotably coupled to the first member such that the first member and the second member are configured to move between an opened position and a closed position with respect to each other around a pivot axis;
wherein, when in the opened position, the first projection abuts the second jaw body, and the slot defines an opening configured to receive a workpiece; and
wherein when in the closed position, the first projection overlaps with the slot such that the projection cutting edge and the slot cutting edge are configured to cut a workpiece positioned within the slot.

11. The cutting tool of claim 10, wherein at least a portion of the projection cutting edge is defined by an angled cut-out formed in the first side of the first jaw body.

12. The cutting tool of claim 11, wherein the angled cut-out defines a linear edge opposite the projection cutting edge of the first projection, wherein, when in the opened position, the second projection and the slot are positioned between the projection cutting edge and the linear edge.

13. The cutting tool of claim 12, wherein the angled cut-out defines an angle between the projection cutting edge and the linear edge, wherein the angle is between 80 degrees and 90 degrees.

14. The cutting tool of claim 10, wherein an angle is defined between the fourth side of the second jaw body and a base of the second projection, wherein the angle is between 70 degrees and 85 degrees.

15. The cutting tool of claim 10, wherein an angle is defined between a base of the second projection and a tip of the second projection, wherein the angle is greater than 110 degrees.

16. A tool for cutting wires, the tool comprising:
a first member comprising a first handle and a first jaw body coupled to the first handle, the first jaw body comprising:
a first side comprising a first tip, a first inner blade with a first linear portion, and a first plurality of grooves positioned between the first tip and the first inner blade;
a second side opposite the first side; and
a first projection coupled to the first side adjacent to the first inner blade, the first projection extending away from the first inner blade, the first projection comprising a first cutting edge;
a second member pivotably coupled to the first member about a pivot axis, the second member comprising a second handle and a second jaw body coupled to the second handle, the second jaw body comprising:
a third side facing the first side, the third side comprising a second tip, a second inner blade with a second linear portion, and a second plurality of grooves positioned between the second tip and the second inner blade;
a fourth side opposite the third side;
a second projection coupled to the fourth side, the second projection extending away from the fourth side; and
a slot defined between the second projection and the fourth side, the slot defining an inner surface with a second cutting edge;
wherein the first member and the second member are configured to move between an opened position and a closed position with respect to each other around the pivot axis; and
wherein, when in the opened position, the first linear portion of the first inner blade and the second linear portion of the second inner blade define an opening configured to receive a workpiece.

17. The tool of claim 16, wherein the opening is defined by an opening angle between the first linear portion and the second linear portion.

18. The tool of claim 17, further comprising a locking mechanism configured to move between a locked position and an unlocked position, wherein, when in the locked position, the locking mechanism limits movement of the first member and the second member with respect to each other.

19. The tool of claim 18, wherein when the locking mechanism is in the locked position, the first member and second member are retained in the opened position such that the opening angle is at least 15 degrees.

20. The tool of claim 18, wherein when the locking mechanism is in the locked position, the first member and second member are retained in the opened position such that the opening angle is at least 18 degrees.
